(19) United States
(12) Patent Application Publication
(10) Pub. No.: US 2026/0241338 A1
(43) Pub. Date: Aug. 20, 2026

(54) VOLATILE ORGANIC COMPOUND REMOVAL DEVICE

(71) Applicant: GRAND MATE CO., LTD., Taichung City (TW)

(72) Inventors: CHIN-YING HUANG, Taichung City (TW); HSIN-MING HUANG, Taichung City (TW); HSING-HSIUNG HUANG, Taichung City (TW); YEN-JEN YEH, Taichung City (TW); KUAN-CHOU LIN, Taichung City (TW)

(73) Assignee: GRAND MATE CO., LTD., Taichung City (TW)

(21) Appl. No.: 19/057,978

(22) Filed: Feb. 20, 2025

(51) Int. Cl. B01D 53/86

(52) U.S. Cl. CPC B01D 53/86; B01D 2257/708; B01D 2265/00

(57) ABSTRACT

A volatile organic compound removal device is defined with a first axis and a second axis perpendicular to the first axis and includes a casing having two opposite sides along the first axis, an inlet pipe, an outlet pipe, at least one heating module, and at least one catalyst module. An inner portion of the casing has a receiving space. The inlet pipe and the outlet pipe respectively penetrate through the two sides of the casing. The at least one heating module and the at least one catalyst module are disposed in the receiving space of the casing and are arranged between the inlet pipe and the outlet pipe along the first axis. Therefore, a decomposition efficiency of the volatile organic compound removal device could be raised.

### BACKGROUND OF THE INVENTION

### Technical Field

The present invention relates generally to a pollutant removal device, and more particularly to a volatile organic compound removal device.

### Description of Related Art

It is known that plenty of organic solvents are used to clean a plurality of wafers to remove a plurality of pollutants attaching on the wafers during the process of the manufacturing (e.g., semiconductor manufacturing). During the wafers cleaned through the organic solvents, volatile organic compounds (VOC) are generated and are volatile to be released to the environment, thereby causing an environmental pollution and damage to the human health. Therefore, volatile organic compounds (VOC) have been important regulated pollutants.

To avoid that volatile organic compounds (VOC) are directly released to cause the environmental pollution and damage to the human health, a volatile organic compound removal device is disposed during the wafers cleaned through the organic solvents to decompose volatile organic compounds (VOC) of a waste gas generated in the process. In addition, due to the large-scale manufacture of the manufacturing, an amount of the waste gas is greatly raised, so that the volatile organic compound removal device could not deal with the waste gas with the great amount within a certain period. As a result, a working efficiency of the volatile organic compound removal device is reduced.

Therefore, the conventional volatile organic compound removal device still has room for improvement. How to provide a volatile organic compound removal device with a raised decomposition efficiency for decomposing volatile organic compounds (VOC), is a problem needed to be solved.

### BRIEF SUMMARY OF THE INVENTION

In view of the above, the primary objective of the present invention is to provide a volatile organic compound removal device, which could raise a decomposition efficiency for decomposing volatile organic compounds through heating and decomposing a waste gas.

The present invention provides a volatile organic compound removal device defined with a first axis and a second axis, wherein the first axis is perpendicular to the second axis. The volatile organic compound removal device includes a casing, an inlet pipe, an outlet pipe, at least one heating module, and at least one catalyst module, wherein the casing has two opposite sides along the first axis. An inner portion of the casing has a receiving space. The inlet pipe and the outlet pipe respectively penetrate through the two sides of the casing. The at least one heating module is disposed in the receiving space of the casing and includes a plurality of heating units, wherein the heating units of the at least one heating module are arranged along the second axis. The at least one catalyst module is disposed in the receiving space of the casing. The at least one catalyst module and the at least one heating module are arranged between the inlet pipe and the outlet pipe along the first axis. The at least one catalyst module is adjacent to the at least one heating module along the first axis and includes a plurality of catalyst units, wherein the catalyst units of the at least one catalyst module are arranged along the second axis.

With the aforementioned design, through the inlet pipe, the at least one heating module, the at least one catalyst module, and the outlet pipe disposed in order along the first axis and the at least one heating module and the at least one catalyst module which are in a staggered arrangement, an effect of heating and catalyzing a decomposition reaction of the waste gas could be achieved, thereby raising the decomposition efficiency of the volatile organic compound removal device.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the volatile organic compound removal device according to an embodiment of the present invention;

FIG. 2 is a perspective view of the volatile organic compound removal device, showing that the volatile organic compound removal device does not include an external box according to the embodiment of the present invention;

FIG. 3 is a top view of the volatile organic compound removal device according to the embodiment of the present invention;

FIG. 4 is a sectional view along the 4-4 line in FIG. 3;

FIG. 5 is an enlarged view of a marked region A1 in FIG. 4;

FIG. 6 is an enlarged view of a marked region A2 in FIG. 4;

FIG. 7 is a schematic view of the volatile organic compound removal device according to the embodiment of the present invention;

FIG. 8 is a schematic view of the heating module and the catalyst module according to the embodiment of the present invention;

FIG. 9 is a schematic view of the heating module and the catalyst module seen from another direction according to the embodiment of the present invention;

FIG. 10 is a schematic view of the heating module according to the embodiment of the present invention;

FIG. 11 is a schematic view of the heating unit according to the embodiment of the present invention;

FIG. 12 is an exploded view of the heating unit according to the embodiment of the present invention;

FIG. 13 is an enlarged view of a marked region A3 in FIG. 12;

FIG. 14 is an exploded view of the catalyst module according to the embodiment of the present invention;

FIG. 15 is a sectional view along the 15-15 line in FIG. 8;

FIG. 16 is a schematic view of the catalyst unit according to the embodiment of the present invention;

FIG. 17 is an exploded view of the catalyst unit according to the embodiment of the present invention.

### DETAILED DESCRIPTION OF THE INVENTION

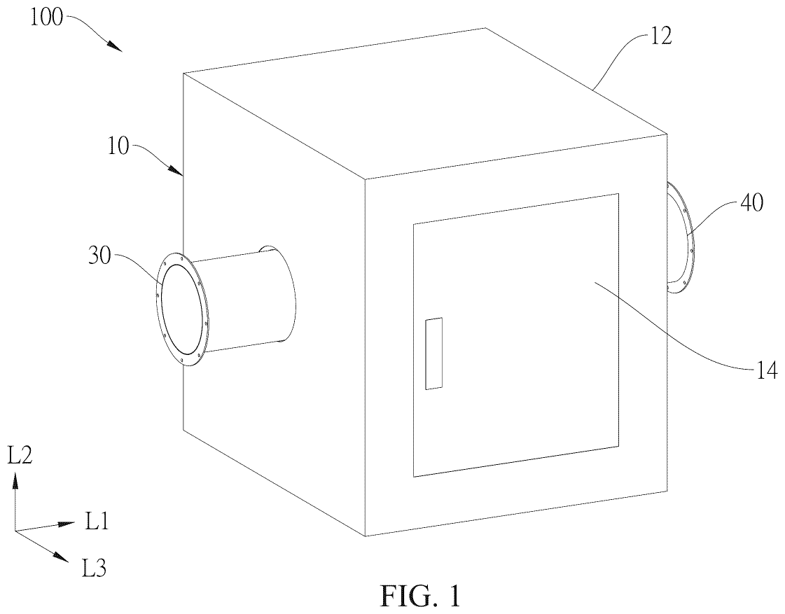

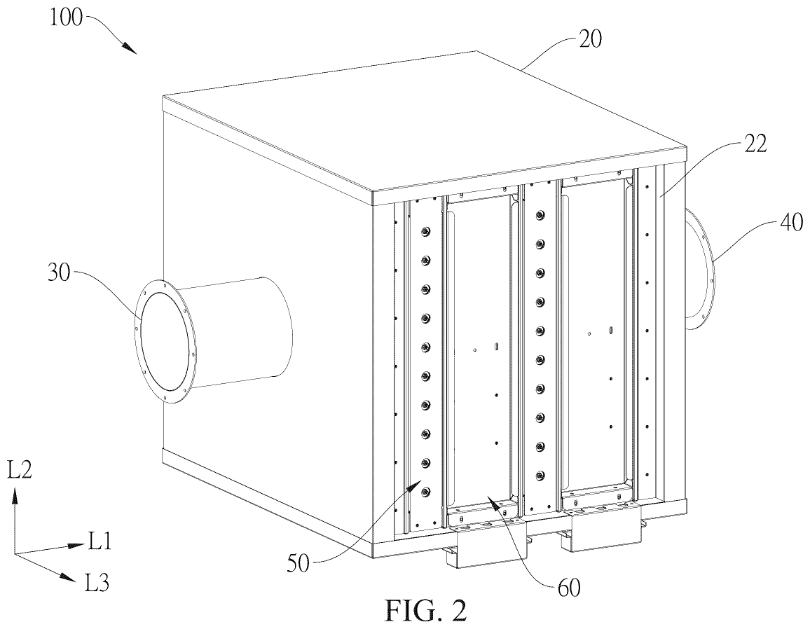

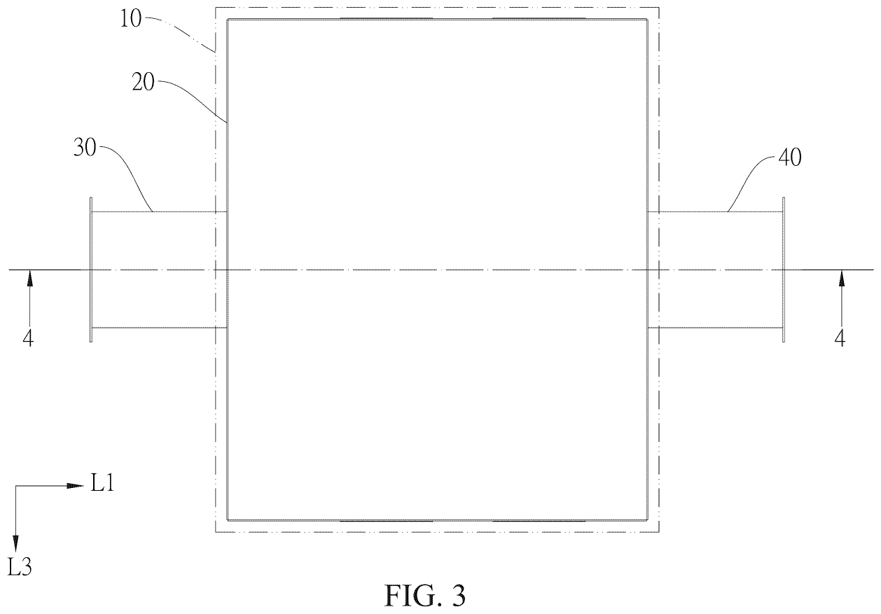

A volatile organic compound removal device 100 according to an embodiment of the present invention is illustrated in FIG. 1 to FIG. 3 and is adapted to remove volatile organic compounds which a gas (not shown) containing. The volatile organic compound removal device 100 is defined with a first axis L1, a second axis L2, and a third axis L3 which are perpendicular to one another. The volatile organic compound removal device 100 includes an external box 10, a casing 20, an inlet pipe 30, an outlet pipe 40, at least one heating module 50, at least one catalyst module 60, a first gas collection cover 70, and a second gas collection cover 80.

The external box 10 includes a box body 12 and two side covers 14, wherein the two side covers 14 face each other, are disposed on the box body 12 along the third axis L3, could move relative to the box body 12. The casing 20 is disposed in the box body 12 and has two opposite sides along the first axis L1. An inner portion of the casing 20 has a receiving space 22. The inlet pipe 30 and the outlet pipe 40 respectively penetrate through two sides of the box body 12 along the first axis L1 and the two sides of the casing 20. The inlet pipe 30 is adapted to input the gas. The outlet pipe 40 is adapted to output the gas which volatile organic compounds have been removed from.

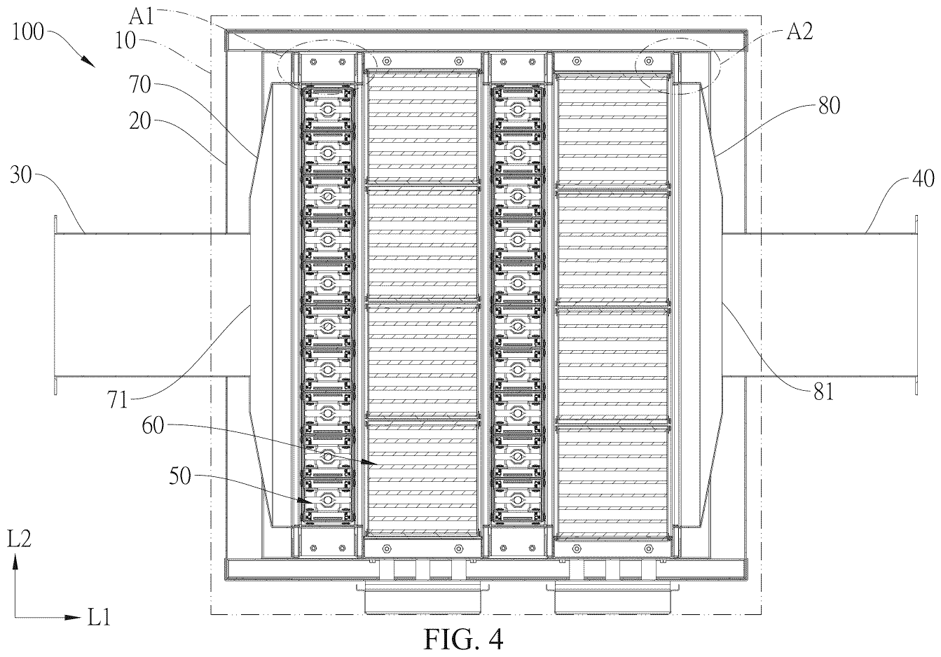

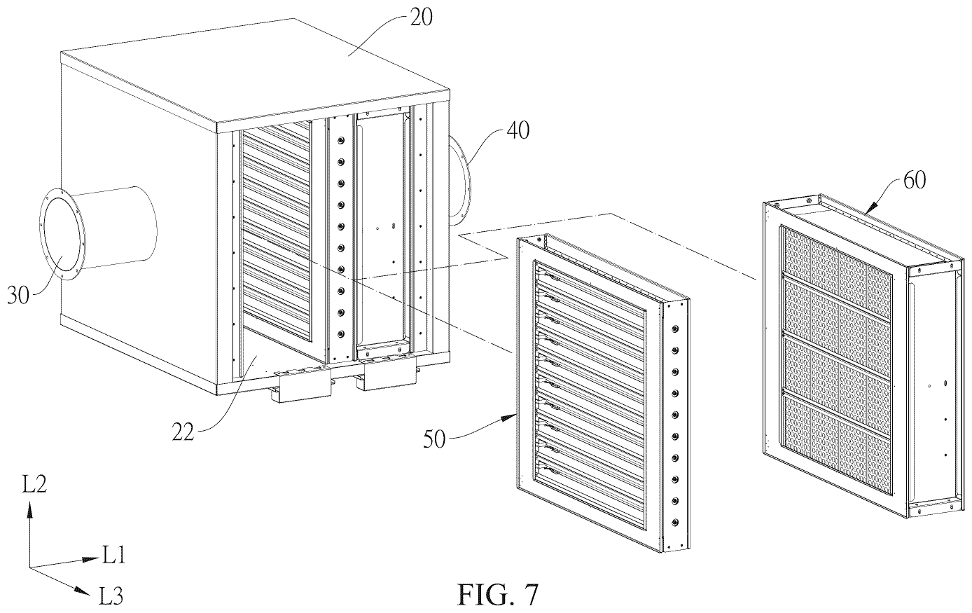

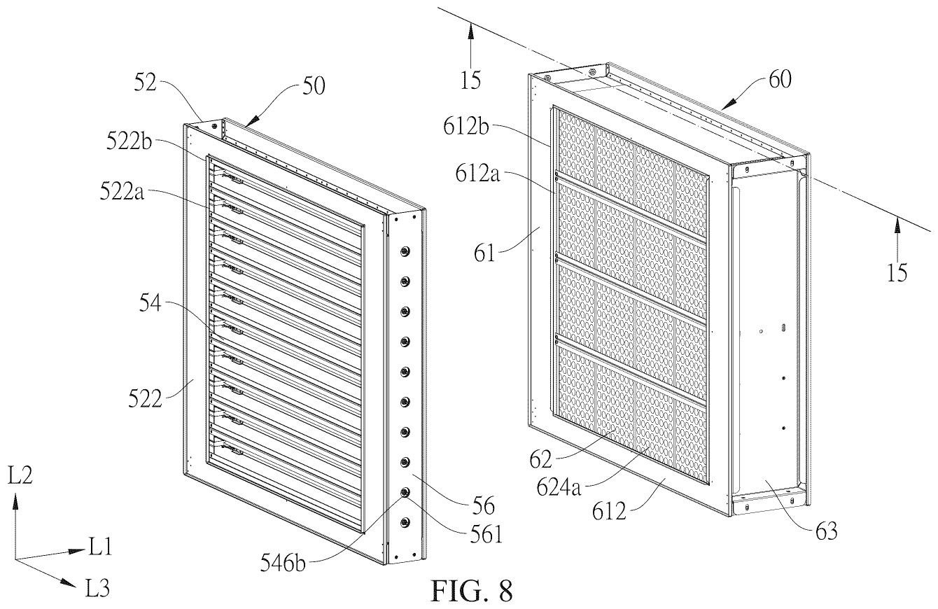

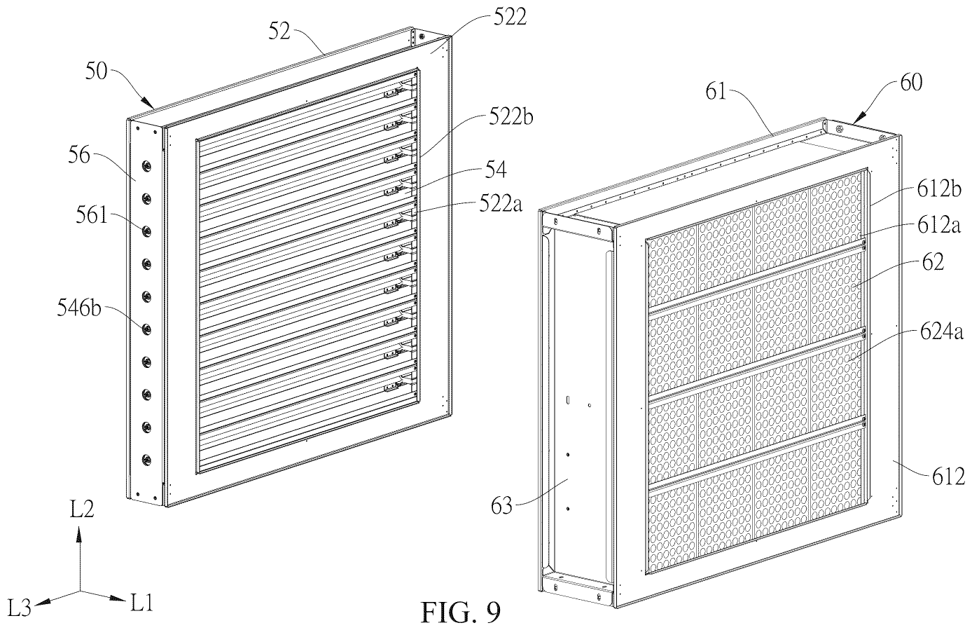

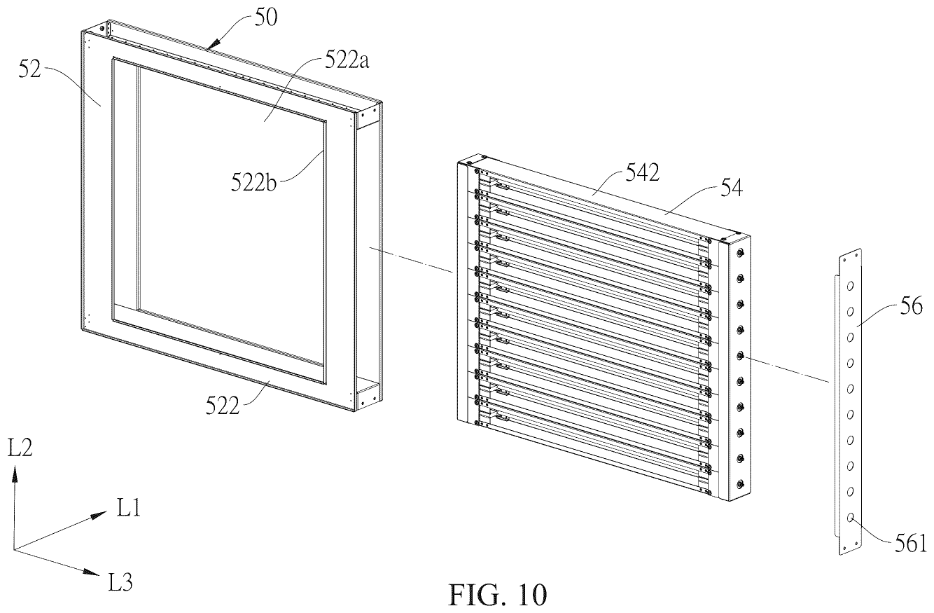

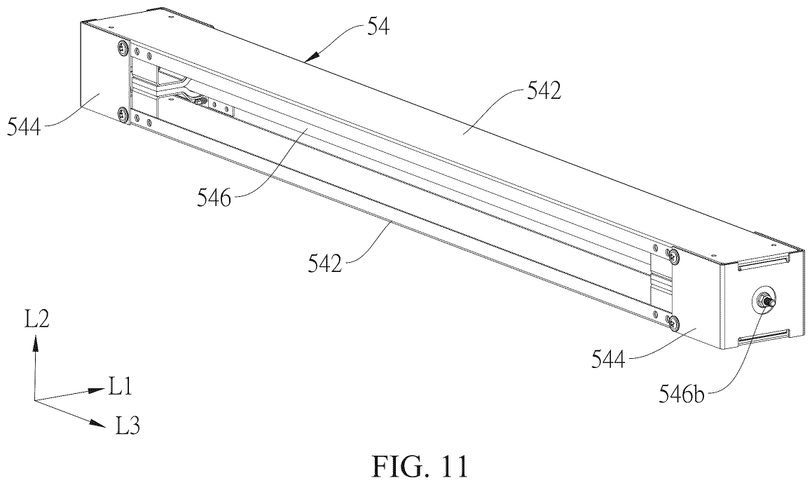

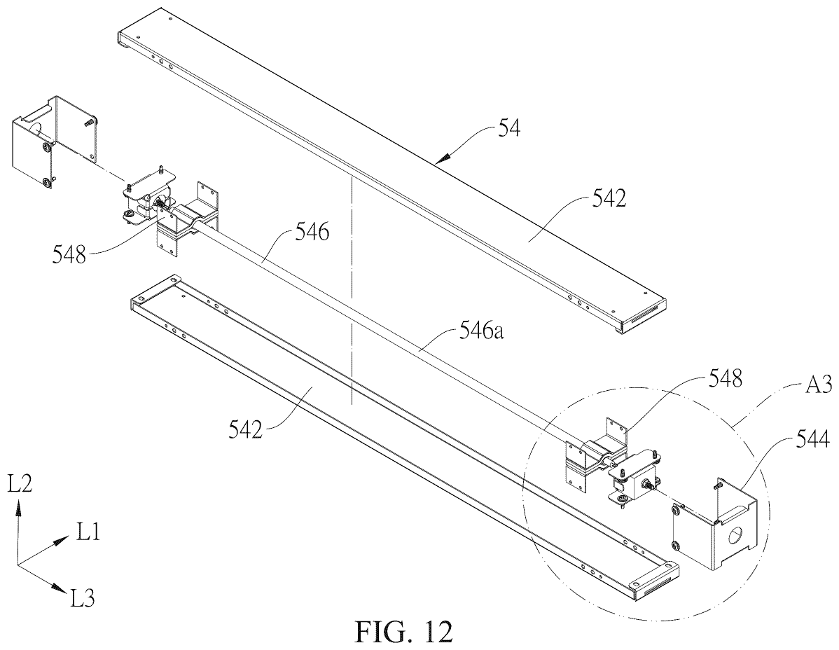

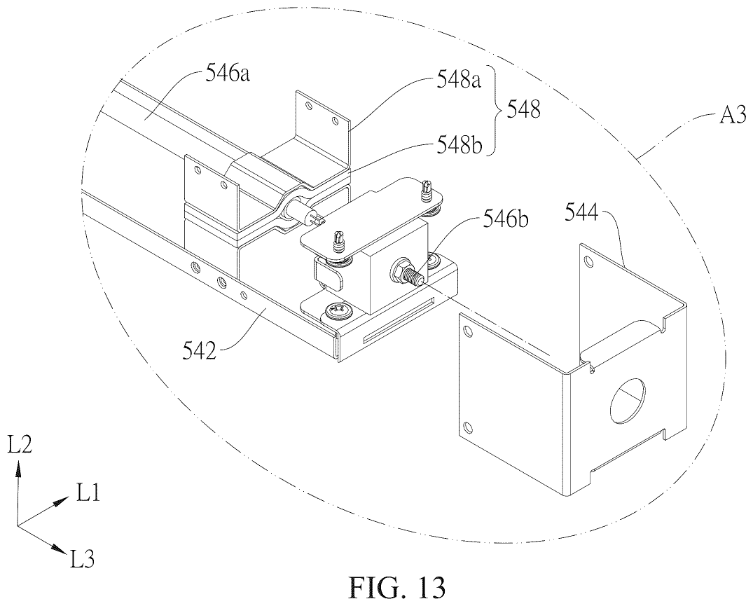

Referring to FIG. 4 and FIG. 7 to FIG. 13, the at least one heating module 50 disposed in the receiving space 22 of the casing 20 along the first axis L1 and includes a first frame 52, a plurality of heating units 54, and two first side boards 56. In the current embodiment, a number of the at least one heating module 50 is two, but not limited thereto. In other embodiments, the number of the at least one heating module 50 could be three or three above. Because two structures of the two heating modules 50 are identical, one of the two heating modules 50 is illustrated as an example in the below description.

The first frame 52 include two first abutting boards 522, wherein the two first abutting boards 522 face each other along the first axis L1. Each of the two first abutting boards 522 has a first opening 522a and a plurality of first folding edges 522b, wherein the two first openings 522a of the first frame 52 face each other along the first axis L1, so that the gas could pass through each of the two first openings 522a from the inlet pipe 30. The first folding edges 522b of each of the two first abutting boards 522 are arranged along an edge of the first opening 522a of each of the two first abutting boards 522.

The heating units 54 of each of the two heating modules 50 are disposed in the first frame 52 of each of the two heating modules 50 and are arranged along the second axis L2. Each of the heating units 54 includes two protective boards 542, two connection frames 544, a heater 546, and a fixing frame 548, wherein the two protective boards 542 face each other along the second axis L2. The two connection frames 544 face each other along the third axis L3. Each of the two connection frames 544 is connected to each of the two protective boards 542. The heater 546 of each of the heating units 54 is disposed between the two protective boards 542 and the two connection frames 544. Therefore, when the gas passes through the two first openings 522a of each of the two heating modules 50, the heaters 546 of the heating units 54 could heat the gas. In the current embodiment, each of the heaters 546 is a heating lamp and includes a quartz outer pipe 546a and a filament (not shown) located in the quartz outer pipe 546a, but not limited thereto. Each of the heaters 546 extends along the third axis L3 and includes two connection terminals 546b, wherein the two connection terminals 546b are connected to two ends of the filament and face each other along the third axis L3. Each of the two connection terminals 546b penetrates through each of the two connection frames 544 and is electrically connected to a wire (not shown) to be connected to a power source (not shown). The power source provides electricity to the heaters 546. The two fixing frames 548 are disposed between the two protective boards 542 and the two connection frames 544. Each of the two fixing frames 548 includes two clamping boards 548a and two buffer pads 548b, wherein the two clamping boards 548a of each of the two fixing frames 548 clamp the heater 546 of each of the heating units 54 along the second axis L2. Each of the two buffer pads 548b is disposed between each of the two clamping boards 548a and each of the heaters 546. In the current embodiment, each of the two buffer pads 548b is made of a ceramic wool, but not limited thereto. In this way, the two clamping boards 548a of each of the heating units 54 could be prevented from directly being in contact with the heater 546 of each of the heating units 54, so that the heaters 546 are not susceptible to vibration. Therefore, a useful life of each of the heaters 546 could be extended.

In the current embodiment, the heating units 54 of each of the two heating modules 50 are disposed in the first frame 52 of each of the two heating modules 50 in a stacking arrangement. Each of the two protective boards 542 of each of the heating units 54 is in contact with the adjacent protective board 542 of the another heating unit 54, but not limited thereto. In other embodiments, each of the two protective boards 542 of each of the heating units 54 could be spaced with the adjacent protective board 542 of the another heating unit 54.

The two first side boards 56 face each other along the third axis L3. The heating units 54 is located between the two first side boards 56. The two first side boards 56 of each of the two heating modules 50 are detachably connected to the first frame 52 of each of the two heating modules 50. After one of the two first side boards 56 is detached, the heating units 54 could be moved out from the receiving space 22 along the third axis L3. For example, when the heating units 54 of one of the two heating modules 50 are broken and need to be replaced, one of the two first side boards 56 of the broken heating modules 50 is first detached and then the broken heating units 54 of the heating module 50 are removed from the receiving space 22 along the third axis L3 without simultaneously moving the two heating modules 50, thereby raising an operational convenience of the volatile organic compound removal device 100. Each of the two first side boards 56 includes a plurality of through holes 561, wherein the through holes 561 of each of the two heating modules 50 are arranged along the second axis L2 and correspond to the heaters 546 of each of the two heating modules 50. Each of the two connection terminals 546b passes through each of the through holes 561 to be electrically connected to each of the wires.

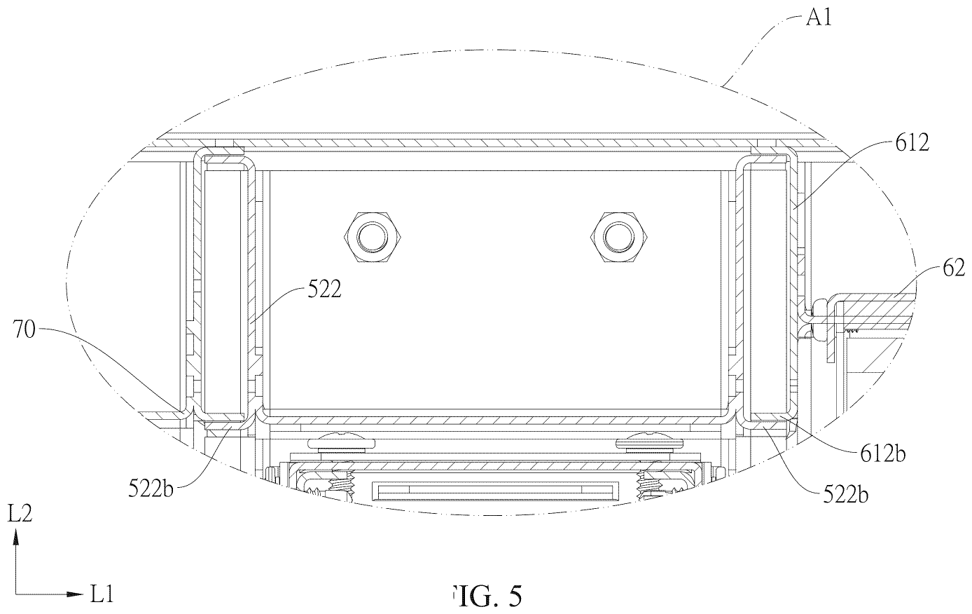

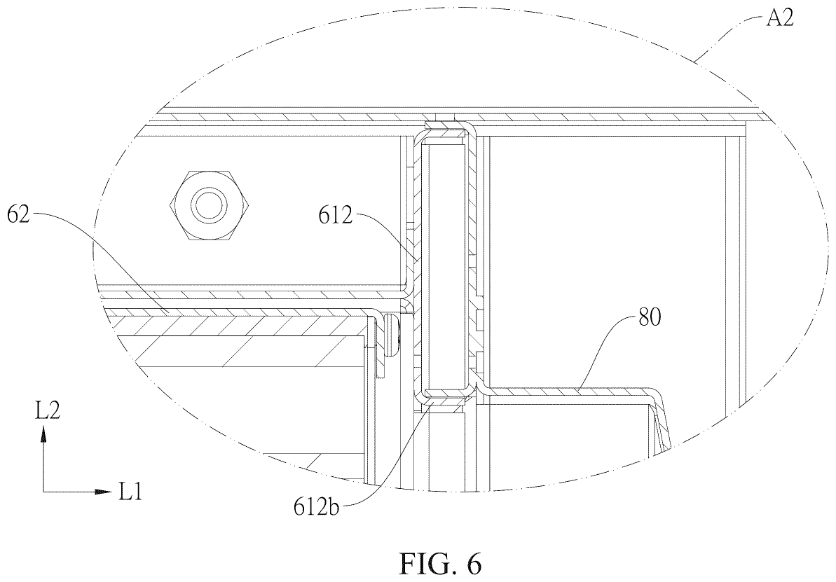

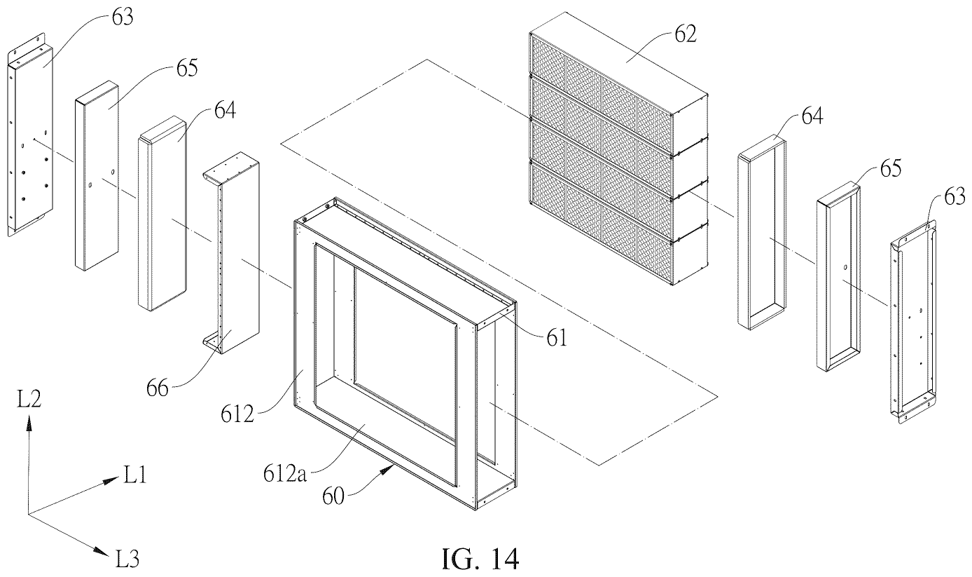

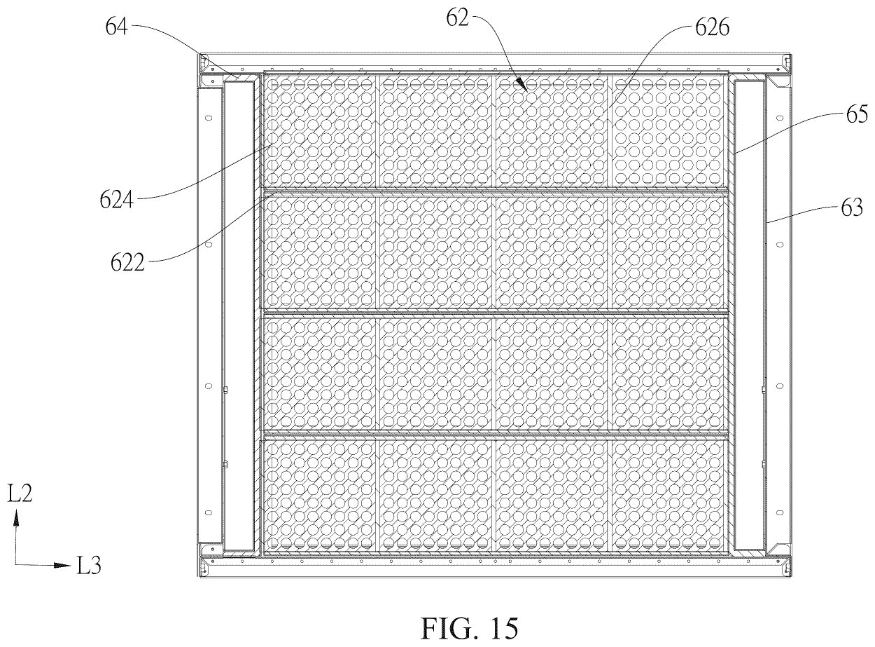

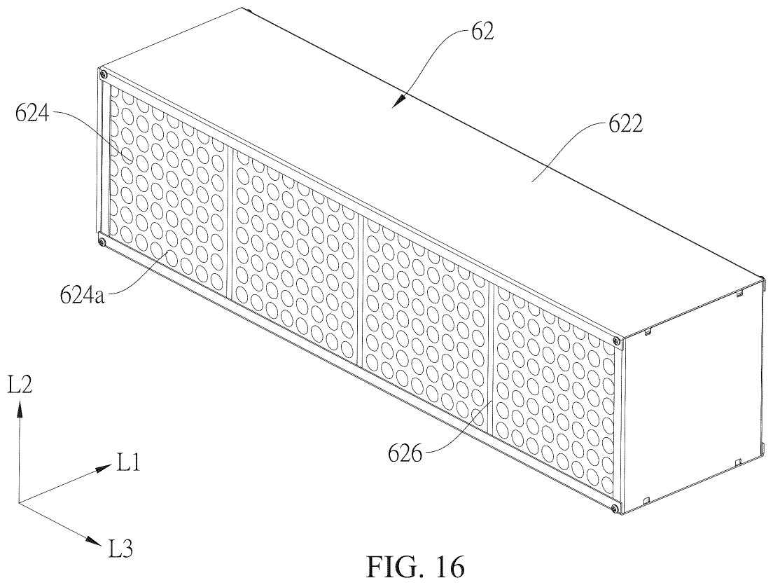

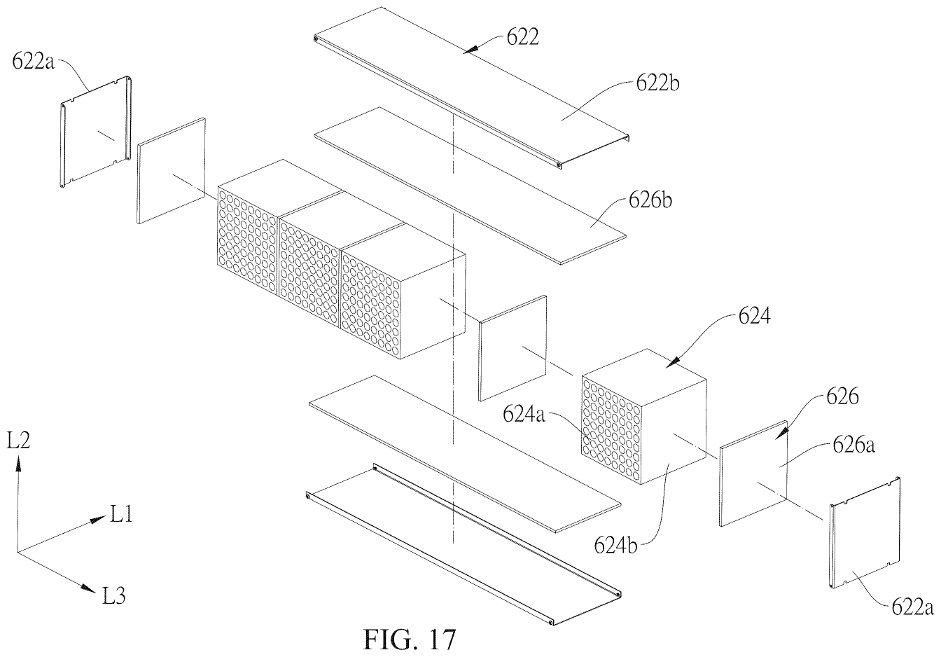

Referring to FIG. 4 to FIG. 9 and FIG. 14 to FIG. 17, the at least one catalyst module 60 is disposed in the receiving space 22 of the casing 20. The at least one catalyst module 60 and the two heating modules 50 are arranged between the inlet pipe 30 and the outlet pipe 40 along the first axis L1. The at least one catalyst module 60 is adjacent to the two heating modules 50 along the first axis L1. In the current embodiment, the at least one catalyst module 60 and the two heating modules 50 are staggered between the inlet pipe 30 and the outlet pipe 40 along the first axis L1, but not limited thereto. The at least one catalyst module 60 includes a second frame 61, a plurality of catalyst units 62, two second side boards 63, two heat insulation pieces 64, two pressing boards 65, and a catalyst board 66. In the current embodiment, a number of the at least one catalyst module 60 is two, but not limited thereto. In other embodiments, the number of the at least one catalyst module 60 could be three or three above based on the demand only if the number of the at least one catalyst module 60 corresponds to the number of the at least one heating module 50. Because two structures of the two catalyst modules 60 are identical, one of the two catalyst modules 60 is illustrated as an example in the below description. Therefore, the gas could sequentially pass through one of the two heating modules 50, one of the two catalyst modules 60, the other heating module 50, and the other catalyst module 60, so that the two heating modules 50 and the two catalyst modules 60 could heat and catalyze a decomposition reaction of the gas to raise a decomposition efficiency of the volatile organic compound removal device 100.

The second frame 61 of each of the two catalyst modules 60 includes two second abutting boards 612, wherein the two second abutting boards 612 face each other along the first axis L1. Each of the two second abutting boards 612 has a second opening 612a and a plurality of second folding edges 612b, wherein the two second openings 612a of the two second frames 61 face each other along the first axis L1. The first opening 522a of each of the two first abutting boards 522 corresponds to the adjacent second opening 612a of the second abutting board 612. The second folding edges 612b of each of the two second abutting boards 612 are arranged along an edge of the second opening 612a of each of the two second abutting boards 612. Through the first folding edges 522b of one of the two first abutting boards 522 of each of the two heating modules 50 abutting against the adjacent second folding edges 612b of the second abutting board 612 of the catalyst module 60, a joint could be prevented from forming between each of the two first openings 522a and the adjacent second opening 612a. Therefore, the gas could be concentrated and pass through one of the two first openings 522a of each of the two heating modules 50 and enters the adjacent second opening 612a, thereby raising the decomposition efficiency of the volatile organic compound removal device 100.

The catalyst units 62 are arranged along the second axis L2 and are disposed the second frame 61 of each of the two catalyst modules 60. Each of the catalyst units 62 includes an inner frame 622, a plurality of catalyst pieces 624, and a buffer assembly 626, wherein each of the inner frames 622 includes two first inner boards 622a and two second inner boards 622b. The two first inner boards 622a of each of the inner frames 622 face each other along the third axis L3. The two second inner boards 622b of each of the inner frames 622 are connected to the two first inner boards 622a of each of the inner frames 622 and face each other along the second axis L2. The catalyst pieces 624 of each of the catalyst units 62 are arranged along the third axis L3 and are disposed in each of the inner frames 622. Each of the catalyst pieces 624 has two ventilation surfaces 624a and a plurality of peripheral surfaces 624b, wherein the two ventilation surfaces 624a face each other along the first axis L1. A plurality of vents of each of the catalyst pieces 624 is formed between the two ventilation surfaces 624a of each of the catalyst pieces 624 and extends along the first axis L1. In the current embodiment, each of the catalyst pieces 624 includes a ceramic piece and a catalyst material, wherein the catalyst material is plated on a surface of the ceramic piece, e.g., each of the two ventilation surfaces 624a, each of the peripheral surfaces 624b, a surface of each of the vents. The catalyst material could discompose volatile organic compounds of the gas at a reaction temperature (e.g., 300° C.). Besides heating the gas, the heaters 546 could heat the adjacent catalyst pieces 624 to the reaction temperature. In the current embodiment, the catalyst material could be platinum or palladium as an example, but not limited thereto.

After the gas passes through one of the two second openings 612a of one of the two catalyst modules 60, the gas first passes through the two ventilation surfaces 624a of each of the catalyst pieces 624 and then passes through the other second opening 612a of the catalyst module 60. Two of the peripheral surfaces 624b face each other along the second axis L2 and another two peripheral surfaces 624b face each other along the third axis L3. The buffer assembly 626 of each of the catalyst units 62 is disposed in the inner frame 622 of each of the catalyst units 62 and surrounds the peripheral surfaces 624b of each of the catalyst pieces 624. The buffer assembly 626 of each of the catalyst units 62 includes a plurality of first buffer components 626a and two second buffer components 626b, wherein the first buffer components 626a and the catalyst pieces 624 are staggered along the third axis L3. The two second buffer components 626b face each other along the second axis L2. Each of the two second buffer components 626b is located between the adjacent peripheral surfaces 624b of the catalyst pieces 624 and the adjacent second inner board 622b. In the current embodiment, the buffer assembly 626 is made of a ceramic wool, but not limited thereto. Therefore, each of the inner frames 622 is prevented from directly being in contact with the catalyst pieces 624, so that the catalyst pieces 624 are not susceptible to vibration and a useful life of each of the catalyst pieces 624 could be extended.

In the current embodiment, the catalyst units 62 of each of the two catalyst modules 60 are disposed in the second frame 61 of each of the two catalyst modules 60 in a staggered arrangement. Each of the two second inner boards 622b of each of the catalyst units 62 is in contact with the adjacent second inner board 622b of the another catalyst unit 62 along the second axis L2, but not limited thereto. In other embodiment, each of the two second inner boards 622b of each of the catalyst units 62 could be spaced with the adjacent second inner board 622b of the another catalyst unit 62.

The two second side boards 63 of each of the two catalyst modules 60 face each other along the third axis L3. The catalyst units 62 are located between the two second side boards 63 of each of the two catalyst modules 60. The two second side boards 63 of each of the two catalyst modules 60 are detachably connected to the second frame 61 of each of the two catalyst modules 60. Each of the two heat insulation pieces 64 and each of the two pressing boards 65 are disposed between the catalyst units 62 and each of the two second side boards 63. Each of the two pressing boards 65 is located between each of the two heat insulation pieces 64 and each of the two second side board 63. Each of the two second side board 63 abuts against each of the two heat insulation pieces 64 through each of the two pressing boards 65 to reach a better sealing effect. Therefore, when the gas passes through each of the two catalyst modules 60, the gas would not leak from two joints between the two second side boards 63 and the second frame 61. The catalyst board 66 of each of the two catalyst modules 60 is disposed between one of the two heat insulation pieces 64 of each of the two catalyst modules 60 and the catalyst units 62 and is aligned with the catalyst units 62. For example, when the catalyst units 62 of one of the two catalyst modules 60 are broken and need to be replaced, one of the two second side boards 63, one of the two pressing boards 65, and one of the two heat insulation pieces 64 are first detached in order, or the other second side board 63, the other pressing board 65, the other heat insulation piece 64, and the other catalyst board 66 are first detached in order. Subsequently, the broken catalyst units 62 of one of the two catalyst modules 60 could be removed from the receiving space 22 along the third axis L3 and be replaced without simultaneously moving the two catalyst modules 60 or further moving the two heating modules 50, thereby raising the operational convenience of the volatile organic compound removal device 100.

Referring to FIG. 4 to FIG. 6, the first gas collection cover 70 and the second gas collection cover 80 are disposed in the receiving space 22 of the casing 20 and face each other along the first axis L1. The first gas collection cover 70 dents towards the inlet pipe 30 and has an inlet 71. The second gas collection cover 80 dents towards the outlet pipe 40 and has an outlet 81. The inlet pipe 30 communicates with the inlet 71. The outlet pipe 40 communicates with the outlet 81. Thee first gas collection cover 70 is adjacent to one of the two heating modules 50 and abuts against the adjacent first folding edges 522b of the first abutting board 522 of the heating module 50, thereby preventing a joint from forming between the first gas collection cover 70 and the adjacent first opening 522a. The second gas collection cover 80 is adjacent to one of the catalyst modules 60 and abuts against the adjacent second folding edges 612b of the second abutting board 612 of the catalyst module 60, thereby preventing a joint from forming between the second gas collection cover 80 and the adjacent second opening 612a. Therefore, when the gas enters the inlet pipe 30 and the inlet 71 in order, the gas could be confined within a range corresponding to the adjacent first openings 522a through the first gas collection cover 70 denting towards the inlet pipe 30, so that the gas could be concentrated and pass through the adjacent first opening 522a. In addition, through the second gas collection cover 80 denting towards the outlet pipe 40, the gas could be confined within a range corresponding to the adjacent second opening 612a, so that the gas could be concentrated and reach the outlet 81. Therefore, the decomposition efficiency of the volatile organic compound removal device 100 could be raised.

With the aforementioned design, in the current embodiment, through the volatile organic compound removal device 100 of the present invention provided with the two heating modules 50 and the two catalyst modules 60 in the staggered arrangement along the first axis L1, the decomposition reaction of the gas could be heated and be catalyzed by the two heating modules 50 and the two catalyst modules 60 during the gas passing through the inlet pipe 30, the inlet 71, one of the two heating modules 50, one of the two catalyst modules 60, the other heating module 50, the other catalyst module 60, the outlet 81, and the outlet pipe 40 in order along the first axis L1. In addition, through the first gas collection cover 70 and the second gas collection cover 80, the gas could be confined within the range corresponding to the adjacent first openings 522a and the range corresponding to the adjacent second opening 612a, so that the gas could be concentrated, pass through the adjacent first opening 522a, and reach the outlet 81. In addition, through the first folding edges 522b and the second folding edges 612b, the gas could be concentrated and pass through the first gas collection cover 70, the first openings 522a, the second openings 612a, and the second gas collection cover 80, thereby raising the decomposition efficiency of the volatile organic compound removal device 100.

It must be pointed out that the embodiments described above are only some preferred embodiments of the present invention. All equivalent structures which employ the concepts disclosed in this specification and the appended claims should fall within the scope of the present invention.

What is claimed is:

1. A volatile organic compound removal device, defined with a first axis and a second axis, wherein the first axis is perpendicular to the second axis; the volatile organic compound removal device comprises:
a casing having two opposite sides along the first axis; an inner portion of the casing has a receiving space;
an inlet pipe and an outlet pipe respectively penetrating through the two sides of the casing;
at least one heating module disposed in the receiving space of the casing and comprising a plurality of heating units, wherein the plurality of heating units of the at least one heating module are arranged along the second axis;
at least one catalyst module disposed in the receiving space of the casing; the at least one catalyst module and the at least one heating module are arranged between the inlet pipe and the outlet pipe along the first axis; the at least one catalyst module is adjacent to the at least one heating module along the first axis and comprises a plurality of catalyst units, wherein the plurality of catalyst units of the at least one catalyst module are arranged along the second axis.

2. The volatile organic compound removal device as claimed in claim 1, wherein the at least one heating module comprises the two heating modules; the at least one catalyst module comprises the two catalyst modules; the two catalyst modules and the two heating modules are staggered between the inlet pipe and the outlet pipe along the first axis.

3. The volatile organic compound removal device as claimed in claim 1, wherein a third axis is defined and is perpendicular to the first axis and the second axis; the volatile organic compound removal device comprises an external box, wherein the external box comprises a box body and two side covers; the casing is disposed in the box body; the inlet pipe and the outlet pipe penetrate two sides of the box body along the first axis; the two side covers face each other and are disposed on the box body along the third axis.

4. The volatile organic compound removal device as claimed in claim 1, wherein the at least one heating module comprises a first frame; the plurality of heating units of the at least one heating module are disposed in the first frame of the at least one heating module; the first frame of the at least one heating module comprises two first abutting boards, wherein the two first abutting boards face each other along the first axis; each of the two first abutting boards of the first frame has a first opening, wherein the two first openings of the two first abutting boards face each other along the first axis; the at least one catalyst module comprises a second frame; the plurality of catalyst units of the at least one catalyst module are disposed in the second frame of the at least one catalyst module; the second frame of the at least one catalyst module comprises two second abutting boards, wherein the two second abutting boards face each other along the first axis; each of the two second abutting boards of the second frame has a second opening, wherein the two second openings of the two second abutting boards face each other along the first axis; the at least one heating module abuts against the adjacent second abutting board of the at least one catalyst module through one of the two first abutting boards; the first opening of each of the two first abutting boards corresponds to the adjacent second opening of each of the two second abutting boards.

5. The volatile organic compound removal device as claimed in claim 4, wherein each of the two first abutting boards of the at least one heating module has a plurality of first folding edges; the plurality of first folding edges of each of the two first abutting boards are arranged along an edge of the first opening of each of the two first abutting boards; each of the two second abutting boards of the at least one catalyst module has a plurality of second folding edges, wherein the plurality of second folding edges of each of the two second abutting boards are arranged along an edge of the second opening of each of the two second abutting boards; the at least one heating module abuts against the plurality of second folding edges of one of the two second abutting boards of the at least one catalyst module which are adjacent through the plurality of first folding edges of one of the two first abutting boards.

6. The volatile organic compound removal device as claimed in claim 4, wherein the plurality of heating units of the at least one heating module are disposed in the first frame of the at least one heating module in a staggered arrangement.

7. The volatile organic compound removal device as claimed in claim 4, wherein a third axis is defined; the third axis is perpendicular to the first axis and the second axis; each of the plurality of heating units comprises two protective boards and a heater, wherein the two protective boards face each other along the second axis; the heater of each of the plurality of heating units is disposed between the two protective boards of each of the plurality of heating units and comprises two connection terminals, wherein the two connection terminals face each other along the third axis.

8. The volatile organic compound removal device as claimed in claim 7, wherein each of the plurality of heating units comprises two fixing frames; the two fixing frames of each of the plurality of heating units are disposed between the two protective boards of each of the plurality of heating units; each of the two fixing frames of each of the plurality of heating units comprises two clamping boards, wherein the two clamping boards of each of the plurality of heating units clamp the heater of each of the plurality of heating units.

9. The volatile organic compound removal device as claimed in claim 7, wherein the at least one heating module comprises two first side boards; the two first side boards of the at least one heating module face each other along the third axis; the plurality of heating units are located between the two first side boards of the at least one heating module; the two first side boards of the at least one heating module are detachably connected to the first frame of the at least one heating module; after one of the two first side boards is detached, the plurality of heating units are moved out from the receiving space along the third axis; each of the two first side boards of the at least one heating module comprises a plurality of through holes, wherein the plurality of through holes of the at least one heating module are arranged along the second axis and respectively correspond to the heaters of the plurality of heating units; each of the two connection terminals of each of the plurality of heating units of the at least one heating module correspondingly passes through each of the plurality of through holes.

10. The volatile organic compound removal device as claimed in claim 4, wherein the plurality of catalyst units of the at least one catalyst module are disposed in the second frame of the at least one catalyst module in a staggered arrangement.

11. The volatile organic compound removal device as claimed in claim 4, wherein a third axis is defined; the third axis is perpendicular to the first axis and the second axis; each of the plurality of catalyst units comprises an inner frame, a plurality of catalyst pieces, and a buffer assembly, wherein the plurality of catalyst pieces are disposed in the inner frame; each of the plurality of catalyst pieces has two ventilation surfaces and a plurality of peripheral surfaces, wherein the two ventilation surfaces face each other along the first axis; the buffer assembly of each of the plurality of catalyst units surrounds the plurality of peripheral surfaces of each of the plurality of catalyst pieces.

12. The volatile organic compound removal device as claimed in claim 11, wherein the at least one catalyst module comprises two second side boards; the two second side boards of the at least one catalyst module face each other along the third axis; the plurality of catalyst units are located between the two second side boards; the two second side boards of the at least one catalyst module are detachably connected to the second frame of the at least one catalyst module; after the two second side boards are detached, the plurality of catalyst units are moved out from the receiving space along the third axis.

13. The volatile organic compound removal device as claimed in claim 12, wherein the at least one catalyst module comprises two heat insulation pieces; each of the two heat insulation pieces of the at least one catalyst module is located between the plurality of catalyst units and each of the two second side boards.

14. The volatile organic compound removal device as claimed in claim 13, wherein the at least one catalyst module comprises two pressing boards; each of the two pressing boards of the at least one catalyst module is located between each of the two heat insulation pieces and each of the two second side boards; each of the two second side boards abuts against each of the two heat insulation pieces through each of the two pressing boards.

15. The volatile organic compound removal device as claimed in claim 5, further comprising a first gas collection cover and a second gas collection cover, wherein the first gas collection cover and the second gas collection cover are disposed in the receiving space of the casing and face each other along the first axis; the first gas collection cover dents towards the inlet pipe and has an inlet; the second gas collection cover dents towards the outlet pipe and has an outlet; the inlet pipe communicates with the inlet; the outlet pipe communicates with the outlet; the first gas collection cover is adjacent to the at least one heating module and abuts against the plurality of first folding edges of one of the two first abutting boards of the at least one heating module which are adjacent; the second gas collection cover is adjacent to the at least one catalyst module and abuts against the plurality of second folding edges of one of the two second abutting boards of the at least one catalyst module which are adjacent.
